(19) United States
(12) Patent Application Publication
(10) Pub. No.: US 2025/0131649 A1
(43) Pub. Date: Apr. 24, 2025

(54) SERVER, METHOD AND COMPUTER PROGRAM FOR GENERATING INDOOR SPACE MODEL

(71) Applicant: KT CORPORATION, Seongnam-si (KR)

(72) Inventors: Yeo Jin YUN, Seongnam-si (KR); Jong Kyeong PARK, Seongnam-si (KR); Zu Cheul LEE, Seongnam-si (KR)

(21) Appl. No.: 18/985,893

(22) Filed: Dec. 18, 2024

Related U.S. Application Data
(63) Continuation of application No. PCT/KR2023/008678, filed on Jun. 22, 2023.

(30) Foreign Application Priority Data
Jun. 22, 2022 (KR) 10-2022-0076148

(51) Int. Cl. G06T 17/00; G06T 7/62

(52) U.S. Cl. CPC G06T 17/00; G06T 7/62

(57) ABSTRACT

an indoor space model generation apparatus for generating an indoor space model includes a derivation unit configured to derive, from a vectorized drawing image, information about space configuration objects included in the drawing image; a space configuration model generation unit configured to generate a space configuration model for each space configuration object in a tile unit based on the information about the space configuration objects; a tile modeling unit configured to perform tile modeling on the generated space configuration model; and an indoor space model generation unit configured to generate the indoor space model by using the space configuration model on which the tile modeling has been performed.

### CROSS-REFERENCE TO RELATED APPLICATIONS

This application is a continuation of International Application No. PCT/KR2023/008678 filed on Jun. 22, 2023, which claims priority to Korean Patent Application No. 10-2022-0076148 filed on Jun. 22, 2022, the entire contents of which are herein incorporated by reference.

### TECHNICAL FIELD

The present disclosure relates to a server, method, and computer program for generating an indoor space model.

### BACKGROUND

As more people prioritize their quality of life and leisure time, interest in personal living space is steadily increasing. For this reason, people put in considerable effort to create their unique living space by searching for their preferred styles of living space or consulting with experts.

Recently, with the rise in popularity of virtual environment-based metaverse services, there has been a growing demand for space modeling.

Conventional metaverse platforms offer services where experts can design a space model that does not exist in the real world or users can customize a space model themselves.

A conventional drawing-based modeling method used in interior design and architecture involves reading the dimensions from the drawing to generate a mesh model. Once a mesh is generated, it is difficult to edit the mesh unless it is generated separately for each module.

In a 3D-based metaverse environment, users can freely design unrealistic spaces. However, to replicate real-world spaces (e.g., home) in a virtual environment, experts directly intervene in a modeling operation. It is not easy to design a space exactly like a real one. Thus, it takes considerable time and cost even for an expert to generate a twin space model. In the metaverse platforms, a home identical to a real one is not modeled and provided in a virtual environment for home space modeling, and automatic modeling is not possible without the efforts of experts.

### DISCLOSURE OF THE INVENTION

### Problems to be Solved by the Invention

In view of the foregoing, the present disclosure is conceived to generate an indoor space model by creating a space configuration model for each space configuration object in a tile unit based on information about space configuration objects included in a drawing image and performing tile modeling on a space configuration model for each space configuration object.

However, the problems to be solved by the present disclosure are not limited to the above-described problems. There may be other problems to be solved by the present disclosure.

### Means for Solving the Problems

According to at least one example embodiment, an indoor space model generation apparatus for generating an indoor space model may include a derivation unit configured to derive, from a vectorized drawing image, information about space configuration objects included in the drawing image; a space configuration model generation unit configured to generate a space configuration model for each space configuration object in a tile unit based on the information about the space configuration objects; a tile modeling unit configured to perform tile modeling on the generated space configuration model; and an indoor space model generation unit configured to generate the indoor space model by using the space configuration model on which the tile modeling has been performed.

According to at least one other example embodiment, a method for generating an indoor space model by an indoor space model generation apparatus may include deriving, from a vectorized drawing image, information about space configuration objects included in the drawing image; generating a space configuration model for each space configuration object in a tile unit based on the information about the space configuration objects; performing tile modeling on the generated space configuration model; and generating the indoor space model by using the space configuration model on which the tile modeling has been performed.

According to at least one other example embodiment, a non-transitory computer-readable medium storing a computer program including a sequence of instructions to generate an indoor space model, which when executed by a computing device, causes the computing device to: derive, from a vectorized drawing image, information about space configuration objects included in the drawing image; generate a space configuration model for each space configuration object in a tile unit based on the information about the space configuration objects; perform tile modeling on the generated space configuration model; and generate the indoor space model by using the space configuration model on which the tile modeling has been performed.

This summary is provided by way of illustration only and should not be construed as limiting in any manner. Besides the above-described exemplary embodiments, there may be additional exemplary embodiments that become apparent by reference to the drawings and the detailed description that follows.

### Effects of the Invention

According to any one of the above-described means for solving the problems of the present disclosure, it is possible to generate an indoor space model by creating a space configuration model for each space configuration object in a tile unit based on information about space configuration objects included in a drawing image and performing tile modeling on a space configuration model for each space configuration object.

Therefore, according to the present disclosure, it is possible to generate a metaverse-type indoor living space based on a drawing image. Further, according to the present disclosure, it is possible to modularize a space into tile units based on information included in the drawing image and also possible to automatically perform modeling of a real indoor space in the metaverse.

### BRIEF DESCRIPTION OF THE DRAWINGS

FIG. 1 is a block diagram of an indoor space model generation apparatus in accordance with an embodiment of the present disclosure.

FIG. 2 is an example depiction illustrating a method for deriving information about space configuration objects from a vectorized drawing image in accordance with an embodiment of the present disclosure.

FIG. 3 is an example depiction illustrating a method for generating a space configuration model for a floor object in accordance with an embodiment of the present disclosure.

FIG. 4A is an example depiction illustrating a method for generating a space configuration model for a wall object in accordance with an embodiment of the present disclosure.

FIG. 4B is an example depiction illustrating a method for generating a space configuration model for a wall object in accordance with an embodiment of the present disclosure.

FIG. 4C is an example depiction illustrating a method for generating a space configuration model for a wall object in accordance with an embodiment of the present disclosure.

FIG. 5A is an example depiction illustrating a method for processing a wall object including a door object in accordance with an embodiment of the present disclosure.

FIG. 5B is an example depiction illustrating a method for processing a wall object including a door object in accordance with an embodiment of the present disclosure.

FIG. 5C is an example depiction illustrating a method for processing a wall object including a door object in accordance with an embodiment of the present disclosure.

FIG. 5D is an example depiction illustrating a method for processing a wall object including a door object in accordance with an embodiment of the present disclosure.

FIG. 5E is an example depiction illustrating a method for processing a wall object including a door object in accordance with an embodiment of the present disclosure.

FIG. 6A is an example depiction illustrating a multi-vector segmentation method of a wall object including a door object in accordance with an embodiment of the present disclosure.

FIG. 6B is an example depiction illustrating a multi-vector segmentation method of a wall object including a door object in accordance with an embodiment of the present disclosure.

FIG. 6C is an example depiction illustrating a multi-vector segmentation method of a wall object including a door object in accordance with an embodiment of the present disclosure.

FIG. 7A is an example depiction illustrating a method for performing tile modeling on a space configuration model in accordance with an embodiment of the present disclosure.

FIG. 7B is an example depiction illustrating a method for performing tile modeling on a space configuration model in accordance with an embodiment of the present disclosure.

FIG. 7C is an example depiction illustrating a method for performing tile modeling on a space configuration model in accordance with an embodiment of the present disclosure.

FIG. 7D is an example depiction illustrating a method for performing tile modeling on a space configuration model in accordance with an embodiment of the present disclosure.

FIG. 8 is an example depiction illustrating a method for generating an indoor space model in accordance with an embodiment of the present disclosure.

FIG. 9 is a flowchart illustrating a method for generating an indoor space model in accordance with an embodiment of the present disclosure.

### BEST MODE FOR CARRYING OUT THE INVENTION

Hereafter, example embodiments will be described in detail with reference to the accompanying drawings so that the present disclosure may be readily implemented by those skilled in the art. However, it is to be noted that the present disclosure is not limited to the example embodiments but can be embodied in various other ways. In the drawings, parts irrelevant to the description are omitted for the simplicity of explanation, and like reference numerals denote like parts through the whole document.

Throughout this document, the term “connected to” may be used to designate a connection or coupling of one element to another element and includes both an element being “directly connected” another element and an element being “electronically connected” to another element via another element. Further, it is to be understood that the terms “comprises,” “includes,” “comprising,” and/or “including” means that one or more other components, steps, operations, and/or elements are not excluded from the described and recited systems, devices, apparatuses, and methods unless context dictates otherwise; and is not intended to preclude the possibility that one or more other components, steps, operations, parts, or combinations thereof may exist or may be added.

Throughout this document, the term “unit” may refer to a unit implemented by hardware, software, and/or a combination thereof. As examples only, one unit may be implemented by two or more pieces of hardware or two or more units may be implemented by one piece of hardware.

Throughout this document, a part of an operation or function described as being carried out by a terminal or device may be implemented or executed by a server connected to the terminal or device. Likewise, a part of an operation or function described as being implemented or executed by a server may be so implemented or executed by a terminal or device connected to the server.

Hereinafter, embodiments of the present disclosure will be explained in detail with reference to the accompanying drawings or flowchart.

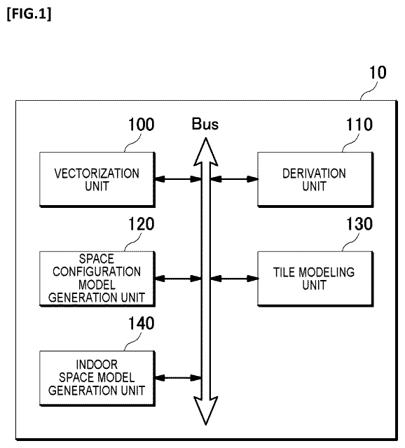

FIG. 1 is a block diagram of an indoor space model generation apparatus 10 in accordance with an embodiment of the present disclosure.

Referring to FIG. 1, the indoor space model generation apparatus 10 may include a vectorization unit 100, a derivation unit 110, a space configuration model generation unit 120, a tile modeling unit 130, and an indoor space model generation unit 140. Nevertheless, the indoor space model generation apparatus 10 illustrated in FIG. 1 is merely an embodiment of the present disclosure, and various modifications may be made based on the components illustrated in FIG. 1.

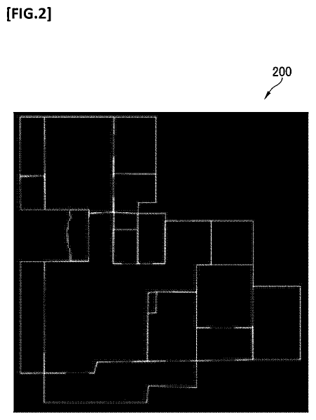

Hereafter, FIG. 1 will be described with reference to FIG. 2 to FIG. 8.

The vectorization unit 100 may vectorize a drawing image by analyzing 2D vector graphics in an SVG (Scalable Vector Graphics) format when receiving input of the drawing image.

In this context, the SVG format uses mathematical vectors to define curves, curved surfaces, etc. included in a pixel-based 2D drawing image. Unlike a method of storing color information in pixel units, the SVG format uses mathematical equations to express the drawing image, resulting in a smaller file size and the absence of aliasing when enlarging the image. Also, if the 2D drawing image is in a PDF or EPS format, it supports vector graphics.

To generate a 3D model of space configuration objects, such as walls, windows, doors, and furniture represented in the drawing image, the present disclosure involves analyzing 2D vector graphics in the SVG format.

To represent a connection structure between spaces and a relationship between space configuration objects within a space as mathematical data, the vectorization unit 100 may convert these connection structures between spaces and the relationships between space configuration objects within a space into a hierarchical structure within an SVG tag in a manner similar to a scene graph.

The derivation unit 110 may derive information about space configuration objects included in the drawing image from the vectorized drawing image. The space configuration objects may include at least one of a floor object, a wall object, and a door object. Herein, the information about the space configuration objects may include, for example, coordinate information corresponding to the space configuration objects.

For example, referring to FIG. 2, a vectorized drawing image 200 is composed of lines of walls of each room.

The derivation unit 110 can derive all lines specified in the vectorized drawing image 200 for each room and then derive information about space configuration objects based on the use of each room. Herein, the information about space configuration objects based on the use of each room can be used as data for automatic furniture placement, wall dividing, and door placement on the divided walls.

The space configuration model generation unit 120 may generate a space configuration model for each space configuration object in a tile unit based on the information about the pl space configuration objects.

The space configuration model generation unit 120 may calculate size information of a floor surface of a floor object based on the coordinate information corresponding to the space configuration objects and generate a space configuration model for the floor object based on the calculated size information of the floor surface.

For example, the space configuration model generation unit 120 may search for minimum and maximum values from the coordinate information corresponding to the space configuration objects and calculate the size information of the floor surface that covers an indoor space model (entire twin home) based on the search result.

To convert the coordinate information corresponding to the space configuration objects into 3D coordinates, the space configuration model generation unit 120 may convert X- and Y-coordinates on an image plane into X-, Y- and Z-coordinates in a 3D world coordinate system. In this case, the Y-coordinate, which determines the height of the floor, is set to 0.

Since the converted X-, Y- and Z-coordinates are integers (i.e., pixel-level coordinates) in an image space, a scale factor needs to be applied to adjust the size for conversion to the 3D world coordinate system. Herein, the scale factor is set as a constant value in centimeters in the SVG format and represents the ratio of real-world measurements to pixel measurements in the drawing image. Since 3D modeling uses a meter-scale model, the scale factor is used to convert real-world measurements from centimeters to meters.

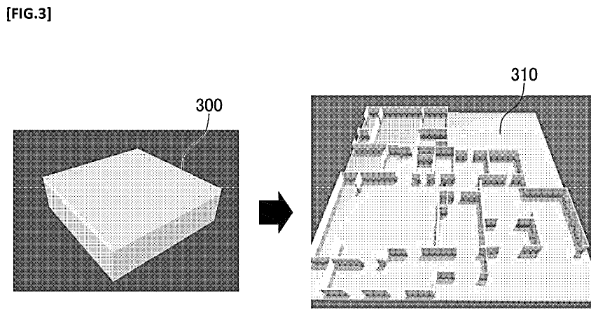

For example, referring to FIG. 3, the space configuration model generation unit 120 may generate a space configuration model 310 for the floor object in a grid format corresponding to the calculated floor surface by using tiles 300 of a predetermined size (e.g., 1 unit).

The space configuration model generation unit 120 may separate a wall object in a room unit from the vectorized drawing image and generate a space configuration model for the separated wall object of the room unit.

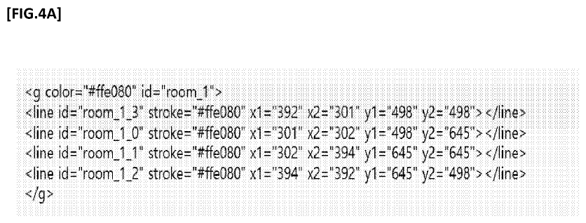

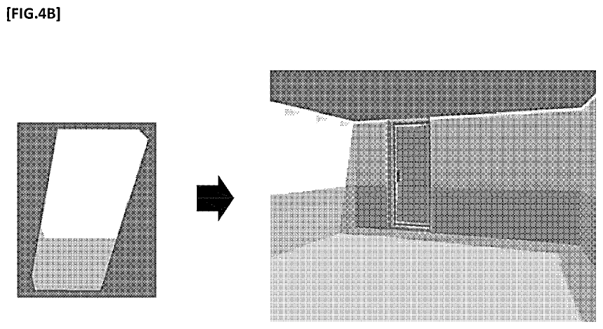

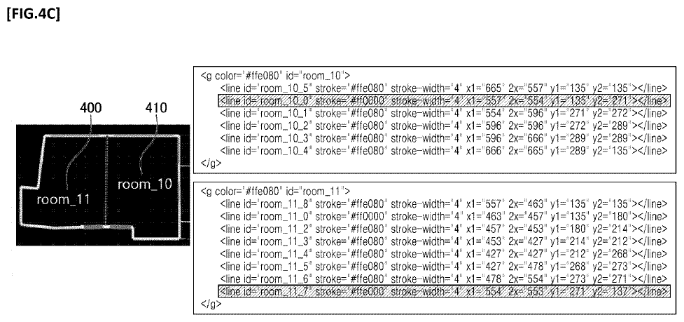

For example, referring to FIG. 4A, the space configuration model generation unit 120 may generate a space configuration model for a wall object of “room_1” by using a first line “room_1_3”, a second line “room_1_0”, a third line “room_1_1”, and a fourth line “room_1_2”, which form the wall object of a space “room_1” separated as a room unit.

Referring to FIG. 4B, the space configuration model generation unit 120 may generate a vector from one of the lines forming the wall object of the space “room_1” as a start point to an end point, divide the vector into wall tiles (e.g., tiles with a height of 2.2 meters and a width of 1 meter), and generate a space configuration model for the wall object of “room_1” by connecting the wall tiles. In this case, the space configuration model generation unit 120 may decorate an inner wall between rooms with a different wallpaper (texture) for each room and model the front and back of the same wall object.

When a first wall object of a first space and a second wall object of a second space adjacent to the first space among spaces included in the drawing image are inner walls that adjoin each other and coordinate information of the first wall object does not match coordinate information of the second wall object, the space configuration model generation unit 120 may correct the coordinate information of the first wall object and the coordinate information of the second wall object by vector correction.

For example, referring to FIG. 4C, when a wall object “room_11_7” of a space “room_11” 400 and a wall object “room_10_0” of a space “room_10” 410 are inner walls that adjoin each other and coordinate information of the two wall objects does not match each other, the space configuration model generation unit 120 may identify proximity of start and end coordinate points of the wall object “room_11_7” and the wall object “room_10_0” through vector correction for each of the wall object “room_11_7” and the wall object “room_10_0”. Subsequently, the space configuration model generation unit 120 may perform a distance-based proximity measurement algorithm and determine that the wall object “room_11_7” and the wall object “room_10_0” are considered the same wall only when a distance between adjacent points of the wall object “room_11_7” and the wall object “room_10_0” is lower than a threshold value (e.g., 5). When they are the same wall, the space configuration model generation unit 120 may correct the start and end coordinate points of the wall object “room_11_7” and the wall object “room_10_0” to match each other.

Meanwhile, each room space is made up of wall objects, and, thus, a wall object including a door object is located between two or more rooms that adjoin each other. In this case, two overlapping wall objects are divided as if they were a single wall object, and a door object is inserted.

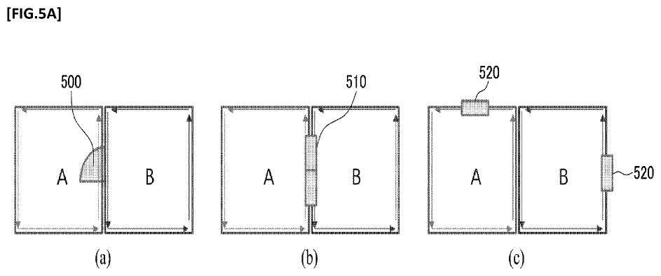

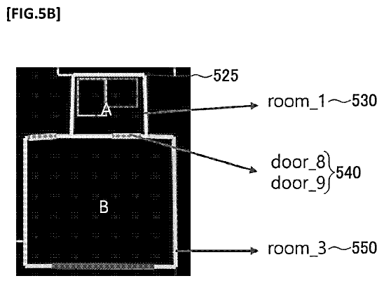

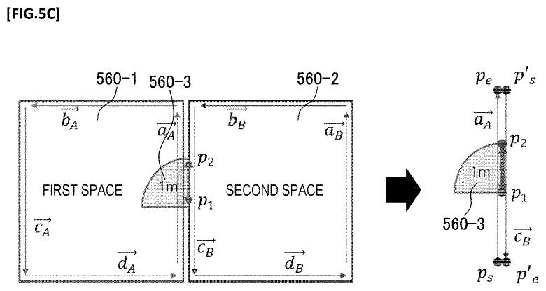

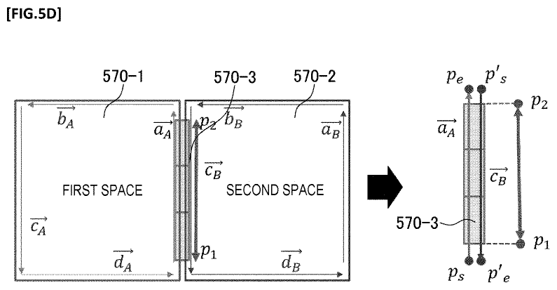

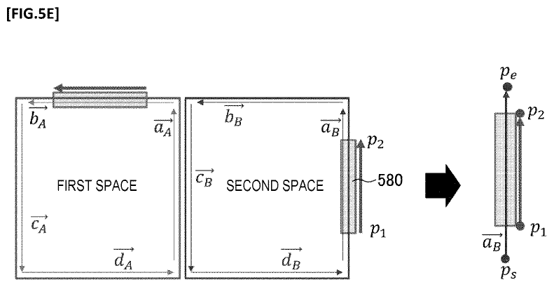

For example, referring to FIG. 5A, space configuration objects corresponding to passageways shown in the drawing image may include a single door object (reference numeral 500 in FIG. 5A-A), a sliding door object (reference numeral 510 in FIG. 5A-B), and a window object (reference numeral 520 in FIG. 5A-C). The space configuration objects corresponding to the passageways shown in the drawing image have different widths in the respective drawings, and a separate process is required for modeling depending on the type of space configuration object corresponding to a passageway.

According to an embodiment of a code that processes a wall object including a door object, a code represents a case where a door object “door_8” 540 included in a wall object “room_1_5” of a space “room_1” 530 is the same as a door object “door_9” 540 included in a wall object “room_3_1” of a space “room_3” 550 and the type of the door object is a single door object as shown in FIG. 5B.

Meanwhile, a method of processing a wall object including a door object will be described in detail.

Referring to FIG. 5B, the space configuration model generation unit 120 may generate a first wall vector in the space “room_1” 530 and a second wall vector in the space “room_3” 550 for adjoining wall objects connected by the door object “door_8” 540 and the door object “door_9” 540 when the space “room_1” 530 and the space “room_3” 550 adjacent to each other are connected through the door object “door_8” 540 and the door object “door_9” 540 in a drawing image 525. In this case, each of the first and second wall vectors may include identification information (ID) of a space corresponding to each wall vector and number information of each wall object.

Since the door object “door_8” 540 and the door object “door_9” 540 connecting the space “room_1” 530 and the space “room_3” 550 share the first wall vector in the space “room_1” 530 and the second wall vector in the space “room_3” 550, door vectors for the door object “door_8” 540 and the door object “door_9” 540 may include identification information for the wall objects, which combines the identification information of each space with the number information of each wall object.

The space configuration model generation unit 120 may search for identification information of wall objects included in door vectors for the door object “door_8” 540 and the door object “door_9” 540 and wall vectors in the same space in order to divide the wall objects.

In order to check whether the door object “door_8” 540 is the same as the door object “door_9” 540, the space configuration model generation unit 120 may align a start point (x1, y1) and an end point (x2, y2) of the door object “door_8” 540 with a start point (x1, y1) and an end point (x2, y2) of the door object “door_9” 540 and check whether door vector directions of the door object “door_8” 540 and the door object “door_9” 540 are opposite to each other.

When it is confirmed that the door object “door_8” 540 is the same as the door object “door_9” 540 as determined by each door vector, the space configuration model generation unit 120 may divide two wall vectors including the door object “door_8” 540 and the door object “door_9” 540 from different directions and generate a space configuration model for the wall objects by using the divided wall vectors.

Referring back to FIG. 1, when the first space and the second space adjacent to each other among the spaces included in the drawing image are connected by the door object, the space configuration model generation unit 120 may generate a space configuration model for an adjacent wall object connected by the door object by using a first wall vector from the first space and a second wall vector from the second space.

For example, referring to FIG. 5C, when a first space 560-1 and a second space 560-2 adjacent to each other are connected by a single door object 560-3, a wall vector a_{A} in the first space 560-1 and a wall vector \vec{c_{B}} in the second space 560-2 for an adjacent wall object connected by the single door object 560-3 are drawn in opposite directions.

Herein, when a distance between a start point and an end point of each of the wall vectors \vec{a_{A}} and \vec{c_{B}} is less than a predetermined threshold value (e.g., 5), the space configuration model generation unit 120 may determine that the wall objects of the first space 560-1 and the second space 560-2 connected by the single door object 560-3 are the same wall object and define a start point of the single door object 560-3 based on a wall object defined first in either the first space 560-1 or the second space 560-2. For example, when the first space 560-1 is defined first, the space configuration model generation unit 120 may divide the wall vector into \vec{pₛp₁} and \vec{p₂pₑ} considering the single door object 560-3 based on the wall vector \vec{a_{A}} of the shared wall object between the first space 560-1 and the second space 560-2.

Since the single door object 560-3 requires only one tile including a door object between walls, the space configuration model generation unit 120 may determine a point p₁ as a start point of the single door object 560-3 and a point p₂ as an end point of the single door object 560-3 by using Equation 1 and divide the wall vector into \vec{pₛp₁} and \vec{p₂pₑ}. Further, as for the opposite wall vector \vec{c_{B}}, the space configuration model generation unit 120 may divide it into \vec{p′ₛp₂} and \vec{p₁p′ₑ} by using the point p₂ calculated by Equation 1.

$${p}_{2} = {p}_{1} + ( \frac{{p}_{s} {p}_{1}}{‖ \vec{{p}_{s} {p}_{1}} ‖} * ScaleFactor ) \qquad [ Equation 1 ]$$

For example, referring to FIG. 5D, a sliding door object 570-3 connecting a first space 570-1 and a second space 570-2 adjacent to each other may have various widths and numbers of doors depending on the size and use of a space. Therefore, the space configuration model generation unit 120 may determine the number of door objects to be arranged in the space based on the length of a door vector for the sliding door object 570-3. Herein, the number of door objects is calculated as shown in Equation 2, and the point p₂ determines the divided vector \vec{p₂pₑ} by using Equation 3. The opposite wall vector \vec{c_{B}} may be divided into \vec{p′ₛp₂} and \vec{p₁p′ₑ} by using the point p₂ calculated by Equation 2 and Equation 3.

$$n = Floor ( \frac{‖ \vec{{p}_{s} {p}_{1}} ‖}{ScaleFactor} ) \qquad [ Equation 2 ]$$

$${p}_{2} = {p}_{1} + ( \frac{\vec{{p}_{s} {p}_{1}}}{‖ \vec{{p}_{s} {p}_{1}} ‖} * ScaleFactor * n ) \qquad [ Equation 3 ]$$

For example, referring to FIG. 5E, since a window object 580 is located on an outer wall in most living spaces, there is no shared wall object. In this case, a wall vector only needs to be divided once. Also, the size of the window object 580 may vary greatly depending on the size and use of the space, and, thus, window tiles may be arranged to fit the width of the window object 580. Here, the height or aspect ratio of the window object 580 is not shown in the drawing, and, thus, it just needs to comply with the standards arbitrarily designed for tiles.

A width w of the window object 580 is calculated as shown in Equation 4, and the point p₂ determines the divided vector \vec{p₂pₑ} by using Equation 5.

$$w = ‖ \vec{{p}_{s} {p}_{1}} ‖ / ScaleFactor \qquad [ Equation 4 ]$$

$${p}_{2} = {p}_{1} + ( \frac{\vec{{p}_{s} {p}_{1}}}{‖ \vec{{p}_{s} {p}_{1}} ‖} * ScaleFactor * w ) \qquad [ Equation 5 ]$$

When a wall object among space configuration objects includes a door object and there is no shared wall that includes the door object, the space configuration model generation unit 120 may divide a wall vector of the wall object into vectors.

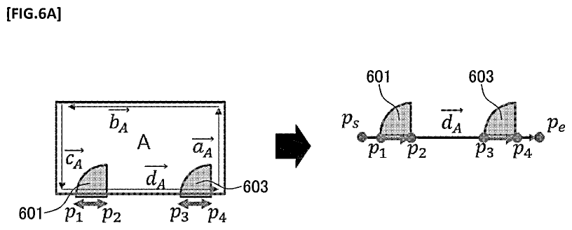

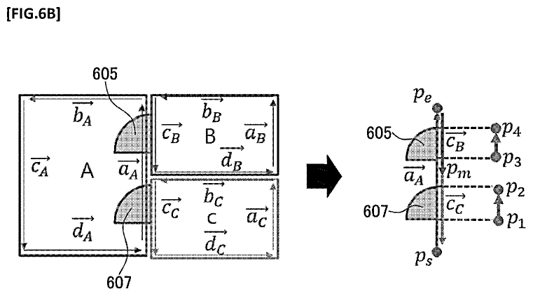

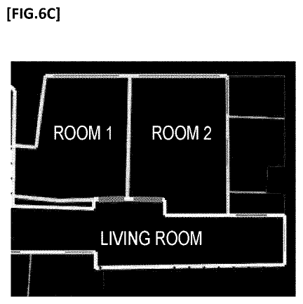

For example, as shown in FIG. 6A, when a first door object 601 and a second door object 603 included in the same wall object have different start and end points from each other and there is no wall that includes both the first door object 601 and the second door object 603, it can be determined that the wall object includes door objects.

The space configuration model generation unit 120 may divide a wall vector d_{A} for the first wall object included in a space A into vectors \vec{pₛp₁}, \vec{p₂p₃}, and \vec{p₄pₑ}. Herein, the positions of the points p₂ and p₄ may be determined considering the space configuration model for the door object, as shown in Equation 6 and Equation 7.

$${w}_{1} = ‖ \vec{{p}_{1} {p}_{2}} ‖ / ScaleFactor , {w}_{2} = ‖ \vec{{p}_{3} {p}_{4}} ‖ / ScaleFactor \qquad [ Equation 6 ]$$

$${p}_{2} = {p}_{1} + ( \frac{\vec{{p}_{s} {p}_{e}}}{‖ \vec{{p}_{s} {p}_{e}} ‖} * ScaleFactor * {w}_{1} ) , {p}_{4} = {p}_{3} + ( \frac{\vec{{p}_{s} {p}_{1}}}{‖ \vec{{p}_{s} {p}_{1}} ‖} * ScaleFactor * {w}_{2} ) \qquad [ Equation 7 ]$$

When a wall object among space configuration objects includes a door object and there is a shared wall that includes the door object, the space configuration model generation unit 120 may divide a wall vector of the wall object into a wall vector of a space adjacent to the shared wall.

For example, referring to FIG. 6B, when a first door object 605 and a second door object 607 included in the same wall object have different start and end points from each other and there is walls that includes both the first door object 605 and the second door object 607, it can be determined that spaces is adjacent to each other. This mainly applies to rooms adjacent to a living room space (or a terrace space) (see FIG. 6C).

The space configuration model generation unit 120 may determine the positions of the points p₂ and p₄ by using the wall vector \vec{a_{A}} for the second wall object included in the space A, Equation 6, and Equation 7 and divide the wall vector \vec{a_{A}} into the vectors \vec{pₛp₁}, \vec{p₂p₃}, and \vec{p₄pₑ}.

The space configuration model generation unit 120 may divide the wall vector \vec{c_{B}} for a third wall object included in a space B adjacent to the space A into vectors \vec{pₑp₄} and \vec{p₃pₘ} and divide a wall vector \vec{c_{C}} for a fourth wall object included in a space C adjacent to the space A into vectors \vec{pₘp₂} and \vec{p₁pₛ}.

The tile modeling unit 130 may perform tile modeling on the space configuration model generated for each space configuration object.

For example, the tile modeling unit 130 may perform tile modeling on the space configuration model for the wall object by using the vectors divided by the space configuration model generation unit 120.

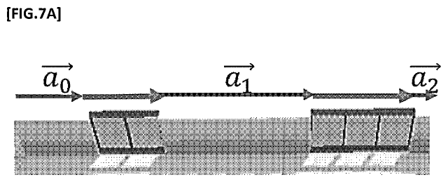

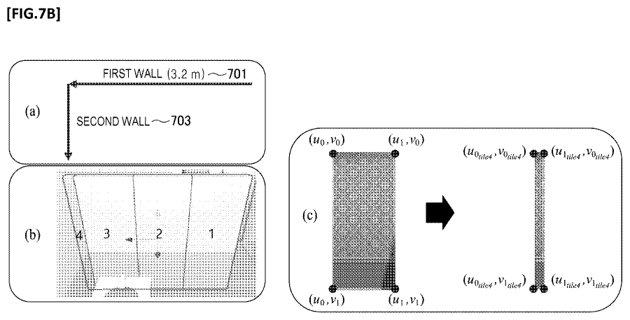

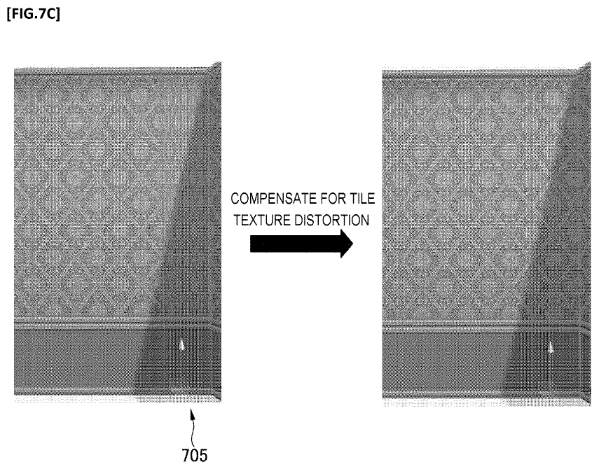

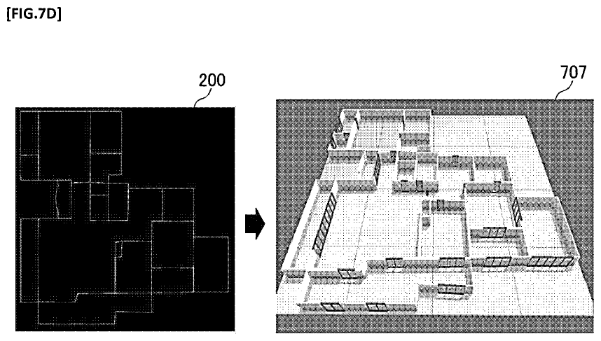

For example, referring to FIG. 7A, the tile modeling unit 130 may convert a vector \vec{a₀} into 3D model coordinates by using a scale factor to convert it into meter-based coordinates and then changing a 2D plane into a plane in the 3D world coordinate system. Herein, since the Y-coordinates indicate the vertical direction in the 3D world coordinate system, it may be set to 0 and the height of a wall tile may be set to a predetermined value (e.g., 2.2 m) considering the height of the floors in typical living environments.

Since the length of the vector is not exactly calculated in meters, the tile modeling unit 130 may perform tile modeling on the wall object to fit the length of the vector in decimals by reducing a wall tile of a predetermined size (e.g., 1 m).

In this case, distortion occurs in the texture of the scale-reduced wall tile. To ensure consistent texture mapping, the tile modeling unit 130 may reset UV coordinates of the wall tile according to a reduction ratio of the tile to minimize texture distortion in the wall object.

For example, referring to FIG. 7B, when modeling is performed on a wall object of FIG. 7B-A as shown in FIG. 7B-B, a first wall 701 and a second wall 703 lying in different directions are connected to each other, they are connected to each other. Assuming that the length of the first wall 701 is 3.2 m during the tile modeling, a total of 4 tiles are arranged and the size of the last fourth tile is adjusted to 0.2 m in width and connected to the second wall 703.

When the structure of the geometrically connected walls is represented, the tile modeling unit 130 may recalculate the UV coordinates of the texture map by using Equation 8 to reduce texture distortion caused by the reduction of the fourth tile (see FIG. 7B-C).

$$if t = 0.2 : \{ \begin{matrix}( {u}_{{0}_{tile 4}} , {v}_{{0}_{tile 4}} ) = ( {u}_{0} , {v}_{0} ) \\ ( {u}_{{1}_{tile 4}} , {v}_{{1}_{tile 4}} ) = ( ( {u}_{1} - {u}_{0} ) \times t , {v}_{1} )\end{matrix} \qquad [ Equation 8 ]$$

For example, referring to FIG. 7C, the tile modeling unit 130 may recalculate the UV coordinates of the texture map by using Equation 8 and perform tile modeling on the wall object based on the recalculated UV coordinates to compensate for texture distortion 705 that occurs when wall tiles are attached to a wall object.

FIG. 7D shows a result 707 of performing tile modeling on a space configuration model for each space configuration object from the vectorized drawing image 200 in the SVG format.

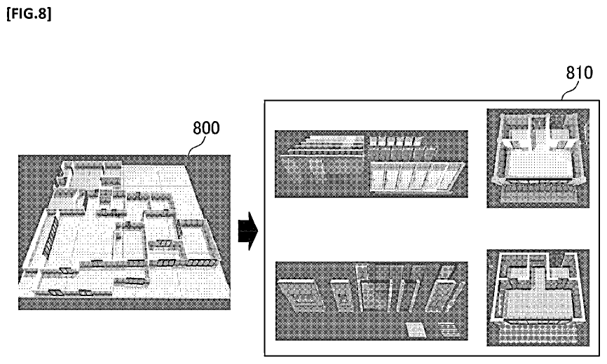

The indoor space model generation unit 140 may generate an indoor space model by using the space configuration model on which the tile modeling has been performed. For example, referring to FIG. 8, the indoor space model generation unit 140 may expand a space configuration model 800 for each space configuration object on which the tile modeling has been performed to various indoor space models 810 by applying style sets.

Meanwhile, it would be understood by a person with ordinary skill in the art that each of the vectorization unit 100, the derivation unit 110, the space configuration model generation unit 120, the tile modeling unit 130, and the indoor space model generation unit 140 can be implemented separately or in combination with one another.

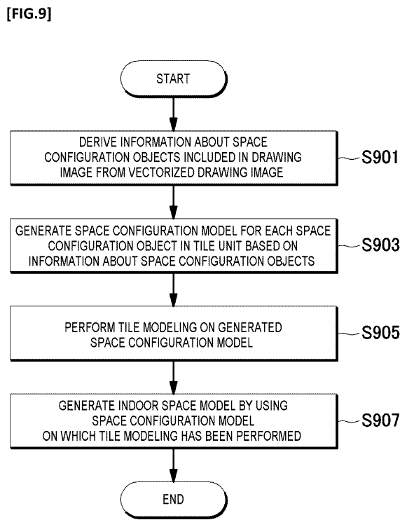

FIG. 9 is a flowchart illustrating a method for generating an indoor space model in accordance with an embodiment of the present disclosure.

Referring to FIG. 9, in a process S901, the indoor space model generation apparatus 10 may derive information about space configuration objects included in a drawing image from a vectorized drawing image. Herein, the space configuration objects may include at least one of a floor object, a wall object, and a door object.

In a process S903, the indoor space model generation apparatus 10 may generate a space configuration model for each space configuration object in a tile unit based on the information about the space configuration objects.

In a process S905, the indoor space model generation apparatus 10 may perform tile modeling on the generated space configuration model.

In a process S907, the indoor space model generation apparatus 10 may generate an indoor space model by using the space configuration model on which the tile modeling has been performed.

In the descriptions above, the processes S901 to S907 may be divided into additional processes or combined into fewer processes depending on an embodiment. In addition, some of the processes may be omitted and the sequence of the processes may be changed if necessary.

The embodiment of the present disclosure can be embodied in a storage medium including instruction codes executable by a computer such as a program module executed by the computer. A computer-readable medium can be any usable medium which can be accessed by the computer and includes all volatile/non-volatile and removable/non-removable media. Further, the computer-readable medium may include all computer storage media. The computer storage media includes all volatile/non-volatile and removable/non-removable media embodied by a certain method or technology for storing information such as computer-readable instruction code, a data structure, a program module or other data.

The above description of the present disclosure is provided for the purpose of illustration, and it would be understood by those skilled in the art that various changes and modifications may be made without changing the technical conception and essential features of the present disclosure. Thus, it is clear that the above-described embodiments are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.

We claim:

1. An indoor space model generation apparatus for generating an indoor space model, comprising:
a derivation unit configured to derive, from a vectorized drawing image, information about space configuration objects included in the drawing image;
a space configuration model generation unit configured to generate a space configuration model for each space configuration object in a tile unit based on the information about the space configuration objects;
a tile modeling unit configured to perform tile modeling on the generated space configuration model; and
an indoor space model generation unit configured to generate the indoor space model by using the space configuration model on which the tile modeling has been performed.

2. The indoor space model generation apparatus of claim 1, further comprising:
a vectorization unit configured to vectorize the drawing image by analyzing 2D vector graphics in an SVG (Scalable Vector Graphics) format.

3. The indoor space model generation apparatus of claim 1,
wherein the space configuration objects include at least one of a floor object, a wall object, and a door object.

4. The indoor space model generation apparatus of claim 3,
wherein the space configuration model generation unit is further configured to calculate size information of a floor surface of the floor object based on coordinate information corresponding to the space configuration objects, and generate a space configuration model for the floor object based on the calculated size information of the floor surface.

5. The indoor space model generation apparatus of claim 4,
wherein the space configuration model generation unit is further configured to generate a space configuration model for the floor object in a grid format corresponding to the calculated floor surface by using a tile of a predetermined size.

6. The indoor space model generation apparatus of claim 4,
wherein the space configuration model generation unit is further configured to separate a wall object in a room unit from the vectorized drawing image, and generate a space configuration model for the separated wall object of the room unit.

7. The indoor space model generation apparatus of claim 6,
wherein when a first wall object of a first space and a second wall object of a second space adjacent to the first space among spaces included in the drawing image are inner walls that adjoin each other and coordinate information of the first wall object does not match coordinate information of the second wall object, the space configuration model generation unit is further configured to correct the coordinate information of the first wall object and the coordinate information of the second wall object by vector correction.

8. The indoor space model generation apparatus of claim 4,
wherein when the first space and the second space adjacent to each other among the spaces included in the drawing image are connected by the door object, the space configuration model generation unit is further configured to generate a space configuration model for an adjacent wall object connected by the door object by using a first wall vector from the first space and a second wall vector from the second space.

9. The indoor space model generation apparatus of claim 4,
wherein when the wall object among the space configuration objects includes a door object and there is no a shared wall that includes the door object,
the space configuration model generation unit is further configured to divide a wall vector of the wall object into vectors.

10. The indoor space model generation apparatus of claim 4,
wherein when the wall object among the space configuration objects includes a door object and there is a shared wall that includes the door object,
the space configuration model generation unit is further configured to divide a wall vector of the wall object into a wall vector of a space adjacent to the shared wall.

11. A method for generating an indoor space model by an indoor space model generation apparatus, comprising:
deriving, from a vectorized drawing image, information about space configuration objects included in the drawing image;
generating a space configuration model for each space configuration object in a tile unit based on the information about the space configuration objects;
performing tile modeling on the generated space configuration model; and
generating the indoor space model by using the space configuration model on which the tile modeling has been performed.

12. The method for generating an indoor space model of claim 11, further comprising:
vectorizing the drawing image by analyzing 2D vector graphics in an SVG (Scalable Vector Graphics) format.

13. The method for generating an indoor space model of claim 11,
wherein the space configuration objects include at least one of a floor object, a wall object, and a door object.

14. The method for generating an indoor space model of claim 13,
wherein the generating a space configuration model for each space configuration object in a tile unit includes:
calculating size information of a floor surface of the floor object based on coordinate information corresponding to the space configuration objects; and
generating a space configuration model for the floor object based on the calculated size information of the floor surface.

15. The method for generating an indoor space model of claim 14,
wherein the generating a space configuration model for each space configuration object in a tile unit includes:
generating a space configuration model for the floor object in a grid format corresponding to the calculated floor surface by using a tile of a predetermined size.

16. The method for generating an indoor space model of claim 14,
wherein the generating a space configuration model for each space configuration object in the tile unit includes:
separating a wall object in a room unit from the vectorized drawing image; and
generating a space configuration model for the separated wall object of the room unit.

17. The method for generating an indoor space model of claim 16, further comprising:
when a first wall object of a first space and a second wall object of a second space adjacent to the first space among spaces included in the drawing image are inner walls that adjoin each other and coordinate information of the first wall object does not match coordinates information of the second wall object,
correcting the coordinate information of the first wall object and the coordinate information of the second wall object by vector correction.

18. The method for generating an indoor space model of claim 14, further comprising:
when the first space and the second space adjacent to each other among the spaces included in the drawing image are connected by the door object,
generating a space configuration model for each space configuration object in the tile unit includes: generating a space configuration model for an adjacent wall object connected by the door object by using a first wall vector from the first space and a second wall vector from the second space.

19. A non-transitory computer-readable medium storing a computer program including a sequence of instructions to generate an indoor space model, which when executed by a computing device, causes the computing device to:
derive, from a vectorized drawing image, information about space configuration objects included in the drawing image;
generate a space configuration model for each space configuration object in a tile unit based on the information about the space configuration objects;
perform tile modeling on the generated space configuration model; and
generate the indoor space model by using the space configuration model on which the tile modeling has been performed.
